(19) United States
(12) Patent Application Publication
(10) Pub. No.: US 2026/0070387 A1
(43) Pub. Date: Mar. 12, 2026

(54) METHOD FOR REGULATING AN AIR SUSPENSION SYSTEM OF A STATIONARY MOTOR VEHICLE

(71) Applicant: Continental Automotive Technologies GmbH, Hannover (DE)

(72) Inventors: Dominik Eger, Hamburg (DE); Felix Hägele, Neustadt am Rübenberge (DE); Hermann Hoinkhaus, Burgwedel (DE)

(73) Assignee: Continental Automotive Technologies GmbH, Hannover (DE)

(21) Appl. No.: 19/326,096

(22) Filed: Sep. 11, 2025

(30) Foreign Application Priority Data
Sep. 12, 2024 (DE) 102024208711.4

(51) Int. Cl. B60G 17/017; B60G 17/052

(52) U.S. Cl. CPC B60G 17/017; B60G 17/052; B60G 2202/152; B60G 2202/412; B60G 2400/05; B60G 2400/252; B60G 2400/51222

(57) ABSTRACT

A method for regulating an air suspension system of a stationary motor vehicle, includes comparing a predetermined target level position with an actual level position of the vehicle; determining an actual air quantity in at least a number of air springs of the air suspension system and comparing the actual air quantity with a reference air quantity. If the actual level position falls below the target level position and the determined air quantity falls below the reference air quantity, the air springs of the air suspension system are then filled while the actual level position is monitored. If the actual level position continues to be below the target level position or the actual level position does not change, the filling of the air springs is carried out only until the reference air quantity corresponding to the target level position is reached as the actual air quantity in the air springs.

### CROSS REFERENCE TO RELATED APPLICATION

This application claims priority to German Application No. 10 2024 208 711.4, filed Sep. 12, 2024, the contents of such application being incorporated by reference herein.

### FIELD OF THE INVENTION

The invention relates to a method for regulating an air suspension system of a stationary motor vehicle and to an air suspension system with which this method is carried out.

### BACKGROUND OF THE INVENTION

Electronically controllable air suspension systems for level position regulation of a passenger motor vehicle are being used ever more widely. The main components of an air suspension system are air springs filled with compressed air and which provide springing for the vehicle body, and an air supply device which provides the compressed air. These two components are connected to one another via pneumatic lines. Moreover, a wide variety of sensors, such as height and pressure sensors, and an electronic control and regulation device are provided. A wide variety of electromagnetic switching valves which are controlled by the control and regulation device are arranged in the pneumatic lines. It goes without saying that the sensors and the switching valves are connected to the control and regulation device via electrical lines.

There are a wide variety of methods for level regulation of a motor vehicle with an air suspension system. Essentially, it is a matter of setting the motor vehicle to a desired level and maintaining it. As a result of the detection of the height of the motor vehicle with respect to the roadway by means of an appropriate sensor system, the level position of the motor vehicle is adapted according to the situation. For example, after loading the motor vehicle, a height adjustment is carried out or the motor vehicle is lowered during travel in order to save fuel.

The air suspension system allows active changes in the height/level of the vehicle body relative to the road surface by opening and closing certain switching valves. Depending on requirements, the air springs are filled with compressed air or emptied in order to adjust the vehicle level. Height refers to the distance of the vehicle body (bodywork) from the road surface. Because the distance of the vehicle body on the axles of the motor vehicle with respect to the roadway may vary, reference is also made to a level position.

In order to determine the current level position of the motor vehicle, a chassis sensor is generally used which detects the spring travel of the wheel as an unsprung mass in relation to the vehicle body as a sprung mass. Such a chassis sensor is fitted in the region of the wheel suspension or of the spring-damper unit of the motor vehicle in order to determine the spring travel of the wheel in relation to the vehicle body. Such suspension sensors are also referred to as height sensor, vertical sensor, level sensor or spring travel sensor. The spring travel sensor transmits its signal to the electronic control and regulation device of the motor vehicle, in which the signal is processed further.

For the purpose of transport, motor vehicles with air suspension are moved to a special level position, known as the transport level. Usually, this is intended to increase the ground clearance and thereby make it easier to cross thresholds in a loaded state. The electronic control and regulation device wakes up regularly and monitors the state of the air suspension system. If deviations are identified, the level position is corrected to the required desired level. Such deviations may be due to leakage of the system during the transport time.

Usually, the motor vehicles are fastened at the wheels, which does not adversely affect a level correction. However, motor vehicles e.g. are not fastened at the wheels during transport by ship, but e.g. at the towing eyes, i.e. the vehicle body. As a result of the lashing of the vehicle body to the ground, the chassis is clamped and pulled down in such a way that the desired transport position is changed. By means of the holding forces, the structure can, for example be pulled down from an actual height of +50 mm to +40 mm.

However, this also means that the above-described level correction cannot be carried out correctly in such a case. This is because the described compensation function will attempt to correct this height deviation by feeding compressed air into the air springs in order to reach the target level of +50 mm. However, due to the fixing, the vehicle body cannot reach this level position. Rather, there is a risk that the air suspension system will be damaged because the air pressure in the system or in the air springs increases beyond the permissible system limits and as a result can lead to failure of the system as a whole.

In addition, shipping for several weeks also requires correction because natural leakage occurs during this time and compressed air escapes from the system. A certain air quantity must be ensured in the air springs so that the fixing of the motor vehicle is maintained, otherwise the motor vehicle could slip and be damaged.

### SUMMARY OF THE INVENTION

An aspect of the invention aims to provide a method for regulating an air suspension system which avoids the stated disadvantages and ensures a properly filled air suspension system during the transport of the motor vehicle.

According to an aspect of the invention, the following steps are carried out to control an air suspension system of a stationary motor vehicle.
comparing a predetermined target level position with an actual level position of the motor vehicle, and
determining an actual air quantity in at least a number of air springs of the air suspension system and comparing the determined actual air quantity with a reference air quantity, which depends on the target level position, and
if the actual level position falls below the target level position and the determined air quantity falls below the reference air quantity,
that the air springs of the air suspension system are then filled up while the actual level position is monitored, and
if the actual level position continues to be below the target level position or the actual level position does not change, the filling of the air springs is carried out only until the reference air quantity corresponding to the target level position is reached as the actual air quantity in the air springs.

By means of this method, the air suspension system remains protected during the transport of the motor vehicle and is ready to drive immediately upon unloading, because the body immediately sets the transport level as the target level installation.

Preferably, the actual level position is determined by means of a number of height sensors which, on each wheel of the motor vehicle, measure the relative distance of the vehicle body as a sprung mass with respect to the wheel as an unsprung mass.

Preferably, the actual air quantity in the air springs is determined by means of a pressure sensor of the air suspension system and the measured values of the respective height sensors.

The determination of the air quantity is carried out on the basis of the known cross section of the air spring or the generally known geometry of the pressure chamber acting as a spring, as well as the spring-related height value of the air spring and the measured air pressure in the air spring. The height value of the air spring is required because the pressure chamber of the air spring has an elastic volume. The volume enclosed by the air spring rolling bellows varies depending on the spring travel and contour of the rolling piston. To determine the air pressure in the air spring, the pressure sensor provided in the air suspension system is used. The pressure sensor is e.g. arranged in a central position in the air suspension system in order to measure the air pressure in the plurality of air springs in succession with a pressure sensor. If present, the pressure in a pressure accumulator, the volume of which is invariable and known, may also be measured by the pressure sensor. Thus, the air quantity is calculated from the measured pressure in an air spring multiplied by the height or volume thereof. Once the air quantity in all air springs has been determined, the total air quantity in the air suspension system is determined by addition. If present, the air quantity in the pressure accumulator is also taken into consideration.

Preferably, the filling of the air spring is performed by means of a compressor of the air suspension system. This compressor either sucks in ambient air or is supplied with compressed air from the pressure accumulator and delivers the compressed air into the air springs.

### BRIEF DESCRIPTION OF THE DRAWINGS

Further preferred embodiments of the invention will become apparent from the following description of an exemplary embodiment based on the figures.

In particular:

FIG. 1 shows a pneumatic circuit diagram of a closed operating air suspension system,

FIG. 2 shows a stationary motor vehicle which is lashed to a ground,

FIG. 3 shows a flowchart of an exemplary method.

### DETAILED DESCRIPTION OF EXEMPLARY EMBODIMENTS

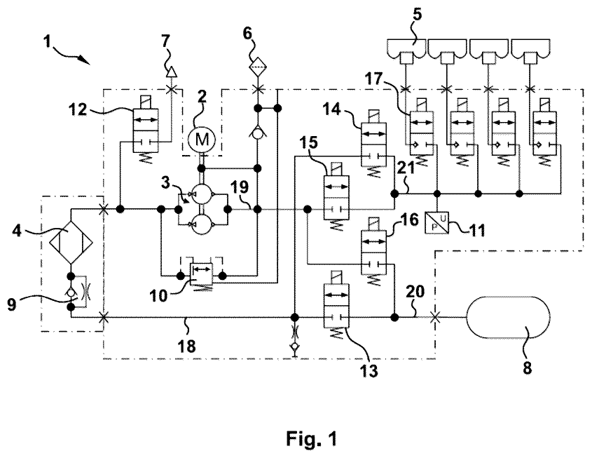

FIG. 1 shows a pneumatic circuit diagram of an electronically regulated air suspension system 1 of a motor vehicle which works in a closed air supply mode. The air suspension system 1 comprises a compressor 3 which is driven by an electric motor 2, wherein the compressor 3 is designed as a double-piston compressor. Multiple air springs 5 as pneumatic regulating units are each assigned to a respective vehicle wheel of the motor vehicle in order to adjust the height of the vehicle body. An air spring valve 17 is connected upstream of each air spring 5.

The air suspension system 1 furthermore comprises a dryer 4 which is designed to dry the air drawn in from the environment by the compressor 3, and a choke check valve 9 connected downstream of the dryer 4. In order to store the aspirated air as system air in the air suspension system 1, a pressure accumulator 8 is provided.

Furthermore, a switching valve device is provided which interconnects the compressor 3, pressure accumulator 8 and air springs 5. This switching valve device comprises four switching valves 13 to 16, which are configured as electronically controllable 2/2-way directional control valves. Also, a pressure sensor 11 is provided to measure the pressure in the various components of the air suspension system. Thus the pressure in the individual air springs 5 and in the pressure accumulator 8 is measured by the pressure sensor 11.

In order to provide compressed system air, the compressor 3 draws in air from the atmosphere via an inlet 6. System air can be expelled from the air suspension system 1 via an outlet 7 with an upstream discharge valve 12. A power-limiting valve 10 is provided bridging the compressor inlet and outlet.

On the outlet side of the compressor 3, a first compressed air line 18 leads to a first switching valve 13 and to a second switching valve 14. On the inlet side of the compressor 3, a second compressed air line 19 leads to a third switching valve 15 and to a fourth switching valve 16. From the pressure accumulator 8, a third compressed air line 20 leads to the first switching valve 13 and to the fourth switching valve 16.

An electronic control and regulation device is not shown, but necessarily belongs to the air suspension system 1, by means of which the compressor 3 or electric motor 2 is actuated and by means of which the plurality of switching valves are opened and closed. Furthermore, by means of the control unit and pressure sensor 11, pressure measurement is performed in the air springs 5 and pressure accumulator 8. In addition, a plurality of height sensors are electrically connected to the control and regulation device in order to measure the respective spring travel of the air springs 5.

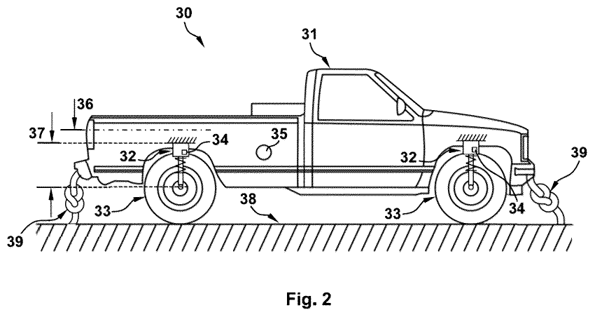

FIG. 2 shows a stationary motor vehicle 30 which is lashed and secured for transport to a ground 38 by means of lashing straps 39. The motor vehicle 30 comprises a vehicle body 31 which, as a sprung mass, is cushioned by a plurality of spring-damper units 32 (preferably air springs or air spring dampers) in relation to the respective wheels 33 as unsprung masses. The spring-damper units 32 of the front and rear axles are assigned respective height sensors 34. It is understood that two spring-damper units 32 with respective height sensors 34 are provided on each axle of motor vehicle 30.

Height sensors 34 are used to measure an actual level position 37 of the vehicle body 31 with respect to wheels 33. An actual level position 37 may differ from a target level position 36. The level position itself is the relative distance between the upper attachment of the spring-damper unit 32 to the vehicle body 31 and the lower fastening of the spring-damper unit 32 to the wheel carrier or wheel 33. Thus, the relative distance between the vehicle body 31 as the sprung mass and the wheel 33 as the unsprung mass is thus measured by the height sensor 34. The measurement signals from height sensors 34 are continuously fed to the electronic control and regulation device 35 of motor vehicle 30 and processed there. There, the measurement signals generally are subject to filtering in order to be able to be processed further as smoothed height values, and are used for the target/actual regulation of the level position of a motor vehicle 30. The measurement signals from height sensors 34 thus provide information about the current level position of the motor vehicle 30.

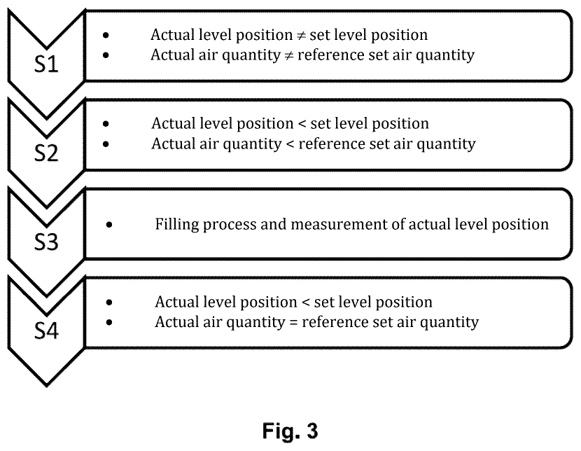

With the flow diagram in FIG. 3, the exemplary method for regulating the air suspension system of a motor vehicle will now be explained.

In a first step S1, the actual level position of the motor vehicle body is compared with a predetermined target level position. This means that e.g. the current level is checked relative to the original level at cyclical intervals during the transport of the motor vehicle. For this purpose, the electronic control and regulation device is, for example, autonomously woken up every 48 hours.

In addition, an air quantity measurement is carried out in order to determine the current actual air quantity present in the air springs. The total air present in the system can also be determined and used as the total system air quantity if the air suspension system is equipped with e.g. a compressed air storage. Independently of the actual vehicle height, the air quantity is also an indicator of the lashed or unlashed state of the vehicle. This is because the air quantity depends on the target level position of the vehicle body. In the normal state of the air suspension system, the necessary air quantity is known for each vehicle height, so that a reference air quantity is present for the target level position which can be used for determining the state of the system. It can thus be assumed that, given a correct quantity of air in the air springs, the vehicle body returns to the target level after loosening of the lashing. When considering the reference air quantity, different degrees of lashing of the vehicle body are also irrelevant.

Once the actual level position and the actual air volume have thus been determined, a comparison is made in a second step S2. If the actual level position falls below the target level position and if the actual air quantity also falls below the reference target air quantity, then there is a need for a filling process of the air springs. Then, in a third step S3, a number of air springs are filled with compressed air. This can for example occur by operating the compressor of the air suspension system, in that the compressor sucks in air from the surroundings, compresses it and conveys it into the air springs. It would also be possible to use the compressed air present in the compressed air storage to fill the air springs directly or to compress the air from the storage further by means of the compressor and then convey it into the air springs.

During the filling process, the actual level position is monitored by means of the height sensors in the third step S3. If the actual level position does not change or does not rise to the target level position to the expected extent, this is an indication that the motor vehicle is lashed at the body. Therefore, if the actual level position is below the target level position, in a fourth step S4 the air springs are only filled until an actual air quantity which corresponds to the reference target air quantity is reached. This compensates for a loss of air quantity during transport, and there is an air quantity in the air springs, which lift the vehicle body to the target level after release. As a result, the motor vehicle is immediately ready for use and there is no need to carry out a compensation process after the motor vehicle has been released.

If the actual level position reaches the target level position during the filling process, the filling process is stopped and it is assumed that the motor vehicle is no longer lashed at the body. It is then at the desired transport height.

### LIST OF REFERENCE NUMERALS

1 air suspension system
2 electric motor
3 compressor
4 dryer
5 air spring
6 inlet
7 outlet
8 pressure accumulator
9 choke check valve
10 power-limiting valve
11 pressure sensor
12 discharge valve
13 first switching valve
14 second switching valve
15 third switching valve
16 fourth switching valve
17 air spring valve
18 first compressed air line
19 second compressed air line
20 third compressed air line
21 fourth compressed air line
30 motor vehicle
31 vehicle body
32 spring-damper unit
33 wheel
34 height sensor
35 electronic control and regulation device
36 target level position
37 actual level position
38 ground
39 lashing straps

1. A method for regulating an air suspension system of a stationary motor vehicle, comprising:
comparing a predetermined target level position with an actual level position of the motor vehicle, and
determining an actual air quantity in at least a number of air springs of the air suspension system and comparing the determined actual air quantity with a reference air quantity, which depends on the target level position, and
if the actual level position falls below the target level position and the determined air quantity falls below the reference air quantity,
the air springs of the air suspension system are then filled up while the actual level position is monitored, and
if the actual level position continues to be below the target level position or the actual level position does not change, the filling of the air springs is carried out only until the reference air quantity corresponding to the target level position is reached as the actual air quantity in the air springs.

2. The method according to claim 1, wherein the actual level position is determined by a number of height sensors which, on each wheel of the motor vehicle, measure the relative distance of the vehicle body as the sprung mass with respect to the wheel as the unsprung mass.

3. The method according to claim 2, wherein the actual air quantity in the air springs is determined by a pressure sensor of the air suspension system and the measured values of the respective height sensors.

4. The method according to claim 1 wherein the air springs are filled by a compressor of the air suspension system.

5. An air suspension system of a motor vehicle having an electronic control and regulation device by which a method according to claim 1 is carried out.
